(19) United States
(12) Patent Application Publication
(10) Pub. No.: US 2012/0272060 A1
(43) Pub. Date: Oct. 25, 2012

(54) ELECTRONIC FILE DELIVERING SYSTEM, RELEVANT MOBILE COMMUNICATION DEVICE, AND RELEVANT COMPUTER PROGRAM PRODUCT

(76) Inventors: Tai-Hung Lin, Taipei City (TW); Po-Yueh Hung, Changhua County (TW)

(21) Appl. No.: 13/451,846

(22) Filed: Apr. 20, 2012

(30) Foreign Application Priority Data
Apr. 20, 2011 (TW) 100113636

(51) Int. Cl. H04L 29/06; H04L 9/32; G06F 7/04

(52) U.S. Cl. 713/165

(57) ABSTRACT

A mobile communication device is disclosed, having a wireless communication interface, a challenge-response module, and a decryption module. The wireless communication interface is used to receive an encrypted electronic file and a challenge value. The challenge-response module is used to generate a response value according to the challenge value and a challenge-response generating algorithm. The decryption module is used to decrypt the encrypted electronic file with the response value. The decryption module may decrypt the encrypted electronic file when the response value generated according to the challenge value and the challenge-response generating algorithm matches the one used to encrypt the electronic file.

### CROSS-REFERENCE TO RELATED APPLICATIONS

This application claims the benefit of priority to Taiwanese Patent Application No. 100113636, filed on Apr. 20, 2011; the entirety of which is incorporated herein by reference for all purposes.

### BACKGROUND

The present disclosure generally relates to mobile communication devices, and, more particularly, to the mobile communication devices capable of decrypting electronic files with a challenge-response algorithm.

Along with the progress of the network technology, the delivery of physical documents has been gradually replaced by the delivery of electronic files on the internet. Thus, it is essential to guarantee the security of the electronic file delivery. For example, the electronic files are usually encrypted before sent to the target recipients. The encrypted electronic files must be decrypted with specific decryption keys so as to ensure the security of the content of the electronic file.

Some file providers adopt user-relevant information as the decryption key of the encrypted electronic file, e.g., the identity number, the date of birth, the account number, and telephone number. A malicious person, however, may easily guess these types of decryption keys so that the security of the electronic file is threatened.

In order to solve the problems described above, some file providers adopt the information irrelevant to the user as the decryption key and send the decryption key to the target recipient. The decryption key may be intercepted by a malicious person so that the security of the electronic file is still threatened.

Some file providers try to enhance the security by frequently changing decryption keys. It, however, enhances the system complexity and is not convenient for the users to keep updating and memorizing the decryption keys.

### SUMMARY

An example embodiment of an electronic file delivery system, comprising: an electronic file providing device, comprising: a database for storing a plurality of challenge-response generating algorithms; a processor for searching the database for a challenge-response generating algorithm of a target recipient according to an information of the target recipient, and for generating a challenge value and a corresponding response value according to the challenge-response generating algorithm of the target recipient and the challenge value; an encryption module for encrypting an electronic file into an encrypted electronic file according to the response value; and a communication interface for transmitting the encrypted electronic file and the challenge value to a mobile communication device; and the mobile communication device, comprising: a wireless communication interface for receiving the encrypted electronic file and the challenge value; a challenge-response module, for storing the challenge-response generating algorithm of the target recipient, and for generating the response value according to the challenge value and the challenge-response generating algorithm of the target recipient; and a decryption module, for decrypting the encrypted electronic file according to the response value.

Another example embodiment of a computer program product on a computer readable medium, for configuring a mobile communication device to perform a decryption key generation operation after receiving an encrypted electronic file and a challenge value, wherein the decryption key generation operation comprises: receiving an input value from a user interface of the mobile communication device; transmitting the input value to a challenge-response module through a communication interface of the mobile communication device; and receiving a response value provided by the challenge-response module according the input value transmitted through the communication interface; wherein the mobile communication device may decrypt the encrypted electronic file according to the response value when the input value matches the challenge value.

Another example embodiment of a computer program product on a computer readable medium, for configuring a mobile communication device to perform a decryption operation after receiving an encrypted electronic file and a challenge value, wherein the decryption operation comprises: transmitting the challenge value to a challenge-response module through a communication interface of the mobile communication device; receiving a response value generated according to the challenge value from the challenge-response module through the communication interface; and decrypting the encrypted electronic file with a decrypting module of the mobile communication device according to the response value.

Another example embodiment of a computer program product on a computer readable medium, for configuring an electronic file providing device to perform a file providing operation, wherein the file providing operation comprises: generating a challenge value and a corresponding response value according to a challenge-response generating algorithm of a target recipient of an electronic file, wherein the challenge value is different from the response value; generating an encrypted electronic file by encrypting the electronic file with the response value; and transmitting the encrypted electronic file and the challenge value to one or more devices of the target recipient.

Another example embodiment of a mobile communication device, comprising: a wireless communication interface for receiving an encrypted electronic file and a challenge value; a challenge-response module for providing a response value according to the challenge value and a challenge-response generating algorithm; and a decryption module for decrypting the encrypted electronic file with the response value.

Another example embodiment of a computer program product on a computer-readable medium, for configuring a mobile communication device to perform a decryption operation after receiving an encrypted electronic file and a challenge value, the decryption operation comprising: displaying a request for entering a challenge value on a display interface of the mobile communication device after receiving a decryption key generating instruction; receiving a first input value from a user interface of the mobile communication device; displaying a response value on the display interface of the mobile communication device when an external storage device storing a challenge-response generating algorithm is detachably coupled with the mobile communication device; receiving a second input value from the user interface; and decrypting the encrypted electronic file with a decryption module of the mobile communication device when the first input value matches to the challenge value and the second input value matches the response value.

It is to be understood that both the foregoing general description and the following detailed description are example and explanatory only and are not restrictive of the invention, as claimed.

### BRIEF DESCRIPTION OF THE DRAWINGS

FIG. 1 shows a simplified functional block diagram of an example electronic file deliver system;

FIG. 2 shows a simplified flowchart of an example file providing method of the file providing device in FIG. 1;

FIG. 3 shows a simplified flowchart of an example file access method of the mobile communication device in FIG. 1;

FIG. 4 shows a simplified flowchart of another example file access method of the mobile communication device in FIG. 1, all in accordance with at least some embodiments of the present disclosure described herein.

### DETAILED DESCRIPTION

Reference will now be made in detail to embodiments of the invention, which are illustrated in the accompanying drawings. The same reference numbers may be used throughout the drawings to refer to the same or like parts or components/operations. Certain terms are used throughout the description and following claims to refer to particular components. As one skilled in the art will appreciate, a component may be referred by different names. This document does not intend to distinguish between components that differ in name but not in function. In the following description and in the claims, the term “comprise” is used in an open-ended fashion, and thus should be interpreted to mean “include, but not limited to . . . .” Also, the phrase “coupled with” is intended to compass any indirect or direct connection. Accordingly, if this document mentioned that a first device is coupled with a second device, it means that the first device may be directly or indirectly connected to the second device through electrical connections, wireless communications, optical communications, or other signal connections with/without other intermediate devices or connection means.

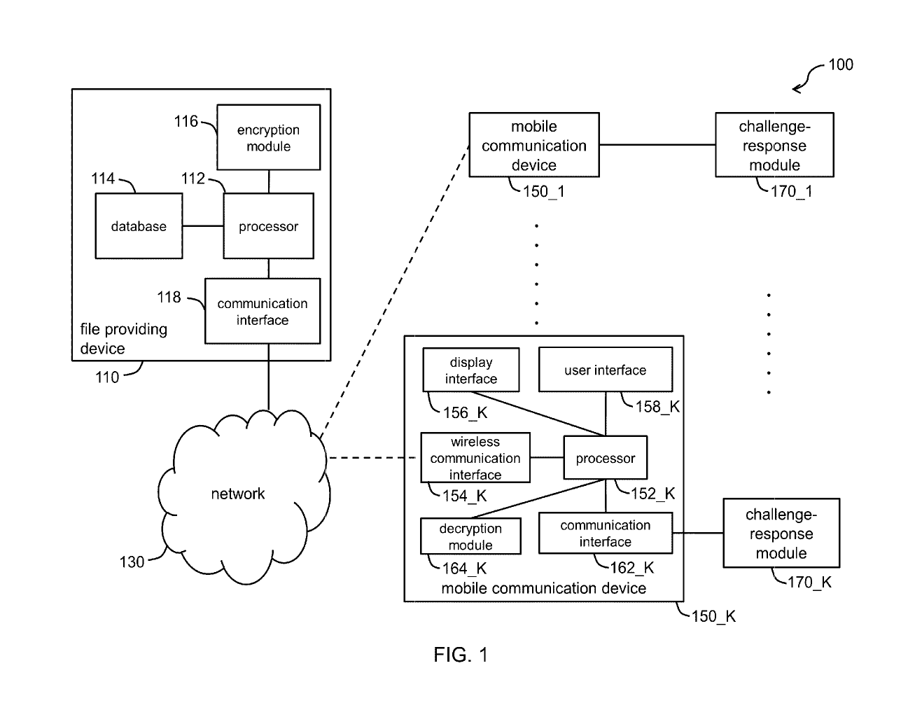

FIG. 1 shows a simplified functional block diagram of an example electronic file delivery system 100, arranged in accordance with at least some embodiments of the present disclosure. The electronic file delivery system 100 comprises a file providing device 110, a network 130, mobile communication devices 150_1˜150_K, and challenge-response modules 170_1˜170_K. For conciseness and easier explanation, the functional block diagram of the mobile communication device 150_K is illustrated in FIG. 1. The mobile communication devices 150_1˜150_K may be realized with the same type of devices, similar devices, or different devices. The challenge-response modules 170_1˜170_K may also be realized with the same type of devices, similar devices, or different devices.

The file providing device 110 may be realized with a computer server. For example, the owner of the file providing device 110 (referred as “the file provider” hereinafter for conciseness) may be the Governments, financial institutions, hospitals, service providing companies, data processing institutions, etc. The mobile communication devices 150_1˜150_K may be realized with mobile phones, tablet computers, personal digital assistants, or other suitable mobile devices. The owner of the mobile communication device may be the client, the customer, the supplier, or the partner of the filer provider. The network 130 may be the internet, the intranet, and/or other suitable wire/wireless network. Besides, the owner of the mobile communication device, which the file provider intends to transmit information to, is referred as “the target recipient” hereinafter for conciseness.

The file providing device 110 may transmit specific electronic file (not shown in FIG. 1) through the network 130 to the target recipient's mobile communication device 150_K. For example, the electronic file may carry the tax information, the trading information, the billing information, the electronic tickets, the medical records, or other personal information. In order to prevent the content of the electronic file from leaking to irrelevant persons, the file providing device 110 encrypts the electronic file to generate an encrypted electronic file and transmits the encrypted electronic file to the mobile communication device 150_K. After receiving the encrypted electronic file, the mobile communication device 150_K must decrypt the encrypted electronic file so as to demonstrate the content of the electronic file to the target recipient.

Before initiating the electronic file delivery service, the file provider may provide each target recipient a unique challenge-response module. The challenge-response module comprises a challenge-response generating algorithm. The target recipient must decrypt the encrypted electronic file transmitted from the file provider with the challenge-response module and the mobile communication device. The challenge-response generating algorithm may be realized with any suitable encryption/decryption algorithms to generate a response value according to a challenge value. Without the challenge-response generating algorithm, a malicious person cannot generate the response value even if he intercepts the challenge value. Moreover, a malicious person still cannot figure out the challenge-response generating algorithm even if he obtains some of the challenge values and the corresponding response values. In this embodiment, the challenge values and the corresponding values generated by the challenge-response generating algorithm are not the same. In another embodiment, some of the response values generated by the challenge-response generating algorithm are the same as the corresponding challenge values.

The challenge values may be selected randomly or in a predetermined order, and the challenge-response generating algorithm generates the response value according to the selected challenge value. The challenge values may be configured to be different from each other, or some of the challenge values may be configured to be the same.

As shown in FIG. 1, the file providing device 110 comprises a processor 112, a database 114, an encryption module 116, and a communication interface 118. The database 114 may be realized with any suitable type of storage device for storing the challenge-response generating algorithms, the information of the target recipients, etc. The electronic file delivery system 110 may comprise several mobile communication devices and the paired challenge-response modules. For example, there are K sets of mobile communication devices 150_1˜150_K and the paired challenge-response modules 170_1˜170_K in FIG. 1. Each set of the mobile communication device and the paired challenge-response module is mapped to a target recipient. The database 114 of the file providing device 110 stores the mapping relation of the target recipients and the corresponding challenge-response generating algorithm. The encryption module 116 may be realized with software, hardware, or the collaboration of software and hardware to encrypt the electronic files. The communication interface 118 may be realized with any suitable wire and/or wireless communication interface for communicating with the network 130.

The mobile communication device 150_K comprises a processor 152_K, a wireless communication interface 154_K, a display interface 156_K, a user interface 158_K, a communication interface 162_K, and a decryption module 164_K. The wireless communication interface 154_K is used to communicate with the network 130. The display interface 156_K is used to display information to the user. The user interface 158_K may comprise a keyboard, a touch panel, an image capture device, an audio input device, and/or other input devices for receiving instructions or information from the user. The communication interface 162_K may be realized with any suitable type of wire and/or wireless communication interface for coupling with the challenge-response module 170_K, e.g., the memory card interfaces, the IEEE 1394 interface, the USB interface, proprietary interfaces, and the interface for communicating with the subscriber identity module (SIM) of the mobile communication device 150_K. The decryption module 164_K may be realized with software, hardware, or the collaboration of software and hardware to decrypt the encrypted electronic file.

In this embodiment, the challenge-response module 170_K is realized with a thin circuit board having the data processing capability for performing the challenge-response generating algorithm of the target recipient. For example, the challenge-response module 170_K may be a think circuit board for sticking to the SIM of the target recipient (a.k.a. the SIM card sticker) provided by the file provider. The challenge-response module 170_K stores the challenge-response generating algorithm of the target recipient for generating a response value according to a challenge value. In other embodiments, instead of storing the challenge-response generating algorithm, the challenge-response module 170_K may store the combinations of the challenge value and the corresponding response value. After the SIM and the challenge-response module 170_K (e.g., the SIM card sticker) are configured in the mobile communicate device 150_K, the mobile communication device 150 may cooperate with the challenge-response module 170_K through the communication interface 162_K.

The functional blocks of the mobile communication device 150_K mentioned above may be integrated according to different design considerations. For example, the display interface 156_K and the user interface 158_K may be realized with a touch screen. Moreover, a single function block mentioned above may also be realized with multiple electronic components.

In the electronic file delivery system in FIG. 1, the file providing device 110 encrypts the electronic file with a response value to generate an encrypted electronic file. The target recipient must decrypt the encrypted electronic file with the same response value. Moreover, the encrypted electronic file may be decrypted by the response value accompanied with additional passwords, e.g., text, files, audio signals, and/or images. The response value and the challenge-response generating algorithm are generated or kept in the file providing device 110, and not transmitted to the network 130. Thus, even if the encrypted electronic file and the challenge value are intercepted, a malicious person still cannot obtain the content of the encrypted electronic file without the response value or the challenge-response generating algorithm. The security of the electronic file delivery may therefore be enhanced.

In one embodiment, the file provider designates a challenge-response generating algorithm for the target recipient and stores the designated challenge-response generating algorithm in the database 114 of the file providing device 110 and in the challenge-response module 170_K. The file providing device 110 and the challenge-response module 170_K may therefore use the same challenge-response generating algorithm to generate the response value. Other users or unauthorized persons cannot know the challenge-response generating algorithm of the target recipient. Therefore, even if the challenge value and the encrypted electronic file are transmitted to other user's mobile device, other users cannot generate the same response value without the challenge-response generating algorithm of the target recipient and cannot decrypt of the encrypted electronic file.

In another embodiment, some of the users may share the same challenge-response generating algorithm and other authentication procedures may be applied. For example, the mobile communication device 150_K may be configured so that the target recipient must enter the personal identification number (PIN) of the SIM before utilizing the challenge-response module 170_K.

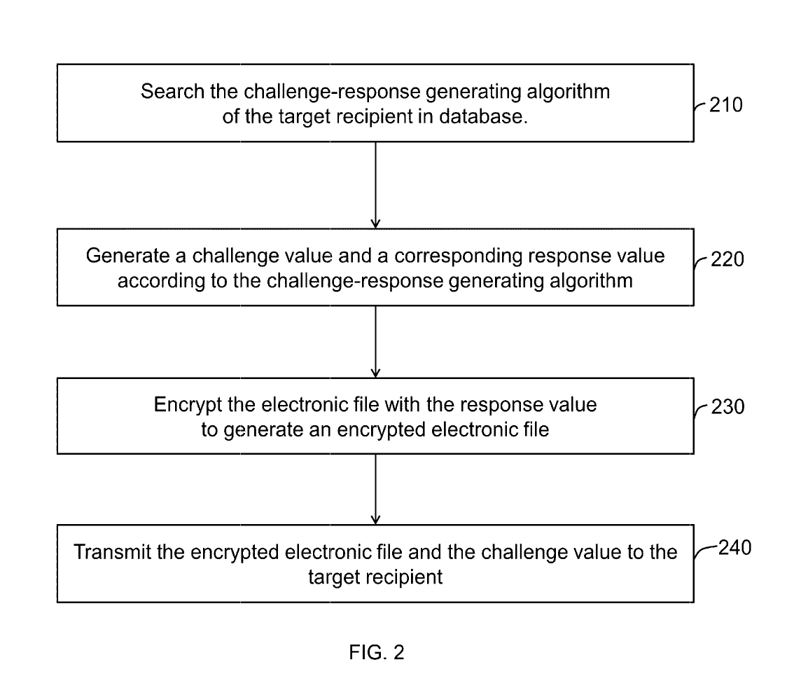

The operation of the electronic file delivery system 100 in FIG. 1 is further explained below with the flowcharts in FIGS. 2-4.

FIG. 2 shows a simplified flow chart of an example file providing method of the file providing device 110, arranged in accordance with at least some embodiments of the present disclosure. The file providing device 110 may provide the electronic file to the mobile communication device 150_K of the target recipient with the method described in FIG. 2.

In the operation 210, the processor 112 searches the challenge-response generating algorithm corresponding to the target recipient in the database 114. The processor 112 may search the challenge-response generating algorithm according to the information of the target recipient in the database 114. For example, the processor 112 may search with the name, the account, the phone number, the mail address, and/or other information of the target recipient.

In the operation 220, the processor 112 generates a challenge value and a corresponding response value according to the challenge-response generating algorithm of the target recipient. In this embodiment, the processor 112 generates the response value according to the challenge value and the challenge-response generating algorithm stored in the database 114. In another embodiment, the database 114 stores multiple sets of the challenge values and the corresponding response values generated according to the challenge-response generating algorithm, and the processor 112 generates a challenge value and a corresponding response value by selecting one of the sets of the challenge values and the corresponding response values.

In the operation 230, the encryption module 116 adopts the response value as the encryption key and encrypts the electronic file with suitable encryption algorithms to generate the encrypted electronic file. For example, the encryption module 116 may adopt one or more symmetric and asymmetric encryption algorithms to encrypt the electronic file.

In the operation 240, the file providing device 110 transmits the encrypted electronic file and the challenge value to the target recipient's mobile communicate device 150_K through the communication interface 118 and the network 130. The mobile communication device 150_K may generate the decryption key according to the received challenge value and the challenge-response module 170_K for decrypting the encrypted electronic file. In this embodiment, the file providing device 110 does not transmit the response value so as to prevent unauthorized persons from intercepting the response value for decrypting the encrypted electronic file.

In the operation 240 above, the encrypted electronic file and the challenge value may be stored in an electronic message, e.g., stored in an email and in a multimedia messaging service (MMS) message. The encrypted electronic file may be the attachment of the electronic message, and the challenge value may be stored in the title, the content, the filename of the attachment, and/or another attachment of the electronic message. In another embodiment, the file providing device 110 may also transmit the challenge value and the encrypted electronic file in multiple electronic messages.

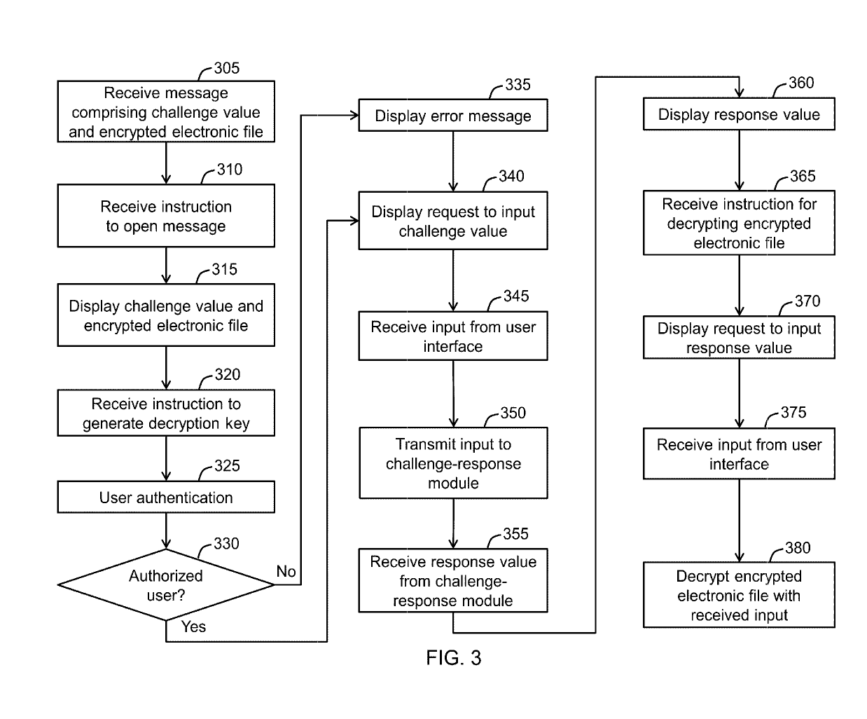

FIG. 3 shows a simplified flowchart of an example file access method of the mobile communication device 150_K, arranged in accordance with at least some embodiments of the present disclosure.

In the operation 305, the mobile communication device 150_K receives the electronic message comprising the challenge value and the encrypted electronic file through the wireless communication interface 154_K.

In the operation 310, the processor 152_K receives the instruction to open the electronic message through the user interface 158_K.

In the operation 315, the processor 152_K displays images and/or text representing the challenge value and the encrypted electronic file on the display interface 156_K.

In the operation 320, the processor 152_K receives the instruction to generate the decryption key through the user interface 158_K. Before generating the decryption key, the processor 152_K may perform an authentication procedure in the operation 325.

In the operation 325, the processor 152_K displays a message on the display interface 156_K for authenticating the user. For example, the processor 152_K may display a password input request on the display interface 156_K. The password may be characters, audio signals, images, biological information, etc. For example, the password may be the PIN of the SIM card, the voice of the user, the image of the user's fingerprint, and/or other information of the user.

In the operation 330, the processor receives the password input through the user interface 158_K for authenticating the user. The processor 152_K compares the password input received from the user interface 158_K with a predetermined value. When the password input matches the predetermined value, the processor 152_K determines the user passes the authentication procedure. The predetermined value may be predetermined characters, audio signals, images, biological information, etc. Moreover, in other embodiments, the predetermined value may be the output of the above information processed by suitable signal processing algorithms, e.g., the digest of the above information processed by a digest algorithm, and the feature of the above information processed by a feature extraction algorithm. If the user passes the authentication procedure, the method proceeds to the operation 340. Otherwise, the method proceeds to the operation 335.

In the operation 335, the processor 152_K displays an error message indicating the user failed to pass the authentication procedure on the display interface 156_K. The method may terminate or return to the operation 325 for repeat the authentication procedure.

In the operation 340, the processor 152_K displays a message on the display device 156_K requesting the user to input the challenge value. In another embodiment, the processor 152_K may output a voice requesting the user to input the challenge value.

In the operation 345, the processor 152_K receives the input from the user interface 158_K. The user may input the challenge value with text, voices, and/or images through the user interface 158_K. In another embodiment, the user may use the attachment of the electronic message, which stores the challenge value, as the input.

In the operation 350, the processor 152_K transmits the received input in the operation 345 to the challenge-response module 170_K through the communication interface 162_K. In this embodiment, the challenge-response module 170_K generates the response value according to the received input and the challenge-response generating algorithm of the target recipient.

In the operation 355, the processor 152_K receives the response value transmitted from the challenge-response module 170_K through the communication interface 162_K.

In the operation 360, the processor 152_K displays the response value received from the challenge-response module 170_K on the display interface 156_K. The user of the mobile communication device 150_K may perceive the response value on the display interface 156_K.

In the operation 365, the processor 152_K receives an instruction from the user interface 158_K for decrypting the encrypted electronic file. For example, the user may click on the icon of the encrypted electronic file and the processor 152_K performs the decryption operations in the operations 370˜380 accordingly.

In the operation 370, the processor 152_K displays a message requesting the user to input the response value as the decryption key on the display interface 156_K, i.e., the response value displayed in the operation 360.

In the operation 375, the processor 152_K receives the input from the user interface 158_K. The user may input with text, voices, and/or images through the user interface 158_K.

In the operation 380, the processor 152_K uses the decryption module 164_K and the input value received in the operation 375 as the decryption key to decrypt the encrypted electronic file. If the encrypted electronic file is decrypted successfully, the processor 152_K may display the content of the encrypted electronic file on the display interface 156_K. For example, the processor 152_K may display the text and/or the images in the encrypted electronic file on the display interface 156_K. If the encrypted electronic file is not decrypted successfully, the processor 152_K may display a decryption error message on the display interface 156_K.

In this embodiment, the challenge-response module 170_K is stuck to the SIM of the mobile communication device 150_K. The challenge-response module 170_K may receive the challenge value through the communication interface 162_K and calculate the corresponding response value according to the stored challenge-response generating algorithm. The generated response value is transmitted to the processor 152_K through the communication interface 162_K so that the processor 152_K may continue the operations mentioned above.

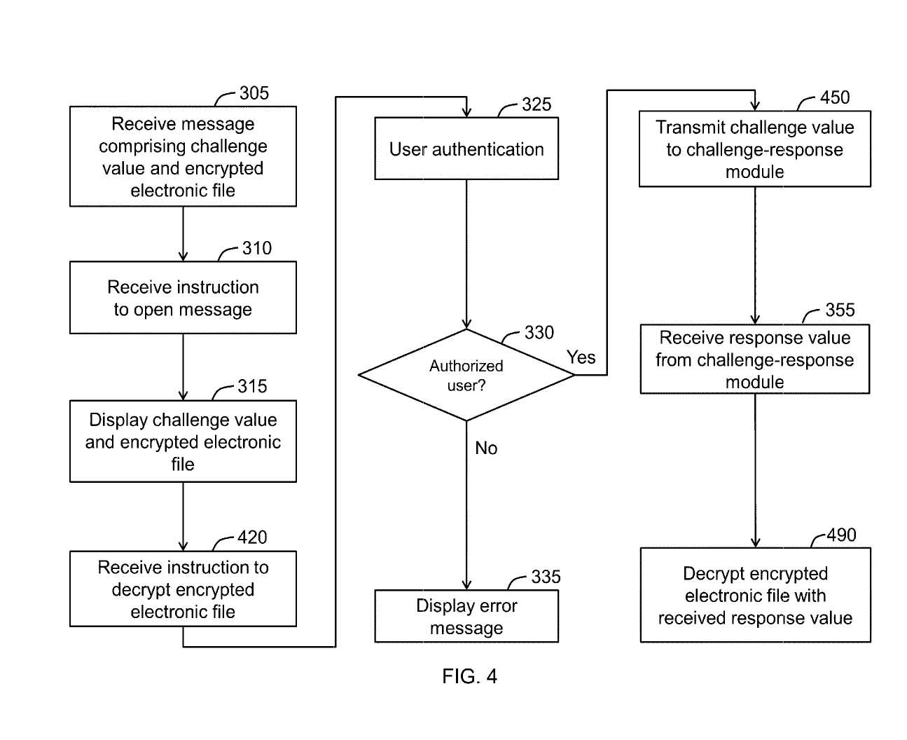

FIG. 4 shows a simplified flowchart of another example file access method of the mobile communication device 150_K, arranged in accordance with at least some embodiments of the present disclosure. In addition to the operations 305, 310, 315, 325, 330, 335, and 355 mentioned above, the method in FIG. 4 further comprises operations 420, 450, and 490. For conciseness, only the operations 420, 450, and 490 are explained below.

In operation 420, the processor 152_K receives the decryption instruction through the user interface 158_K. For example, the user may click on the icon of the encrypted electronic file to act as the decryption instruction. Before performing the decryption operation, the processor 152_K may perform an authentication procedure in the operation 325.

In operation 450, the processor 152_K transmits the challenge value in the electronic message to the challenge-response module 170_K through the communicate interface 162_K. The challenge-response module 170_K may generate the response value according to the stored challenge-response generating algorithm and the received challenge value input.

In operation 490, the processor 152_K receives the response value transmitted from the challenge-response module 170_K through the communication interface 162_K and configures the decryption module 164_K to decrypt the encrypted electronic file by using the response value as the decryption key.

Part of the operations or all of the operations in FIGS. 3 and 4 may also be realized in the form of the computer program product. When the mobile communication device 150_K executes the computer program product, the processor 152_K performs the corresponding operations in FIGS. 3 and 4. For example, the computer program product may comprise the program codes for performing the decryption key generation in operations 340˜360 and/or the decryption operation in operation 450, 355 and 380.

In another embodiment, the order of operations in FIG. 3 or 4 may be configured according to different design considerations. For example, the operations 325 and 330 for authenticating the user may be executed before the operation 305. Thus, the processor 152_K may prevent unauthorized person from using the methods above and provide better protection.

In another embodiment, some of the operations in FIG. 3 or 4 may be omitted. For example, the authentication operations 325, 330, and 335 may be omitted in FIGS. 3 and 4 and the methods proceed to the operations 340 or 450 directly.

In some embodiments, the processor 152_K may terminate the file access methods after the erroneous entries in the authentication operation 330 exceed a predetermined number. In another embodiment, the process 152_K may lock up the file access methods, the mobile communication device 150_K, and/or the challenge-response module 170_K after the erroneous entries in the authentication operation 330 exceed a predetermined number. Thus, the malicious person has lower chances to pass the authentication procedure by continuously retries.

In the embodiment above, the challenge-response module 170_K is realized with a thin circuit board having the data processing capability so as to perform the challenge-response generating algorithm. In other embodiments, the file provider may store the challenge-response generating algorithm of the target recipient in a memory device and/or in the internal memory of the mobile communication device 150_K, e.g., memory cards, USB storage devices, or other memory devices for detachably coupling with the mobile communication device 150_K. The memory device may be configured to be read-only so that the stored challenge-response generating algorithm may not be easily modified. Moreover, part of the operations performed by the challenge-response module 170_K above may also be performed by the processor 152_K. For example, the processor 152_K receives the challenge value in the operation 345 and omits the operations 350 and 355. The processor 152_K reads the challenge-response generating algorithm stored in the challenge-response module 170_K and generates the response value accordingly. In other words, the operations perform by the challenge-response module 170_K with the data processing capability may also be realized with the processor 152_K and a challenge-response module storing the challenge-response generating algorithm.

In the embodiments above, the method in FIG. 3 requires more interactions between the user and the mobile communication device 150_K. Thus, the malicious person may not easily manipulate the mobile communication device 150_K with remotely controlled malware. The method in FIG. 4 requires fewer interactions between the user and the mobile communication device 150_K, e.g., the user does not need to input the challenge value and the response value through the user interface 158_K. Thus, it is more convenient for the user and may reduce the error occurred in the user's manual operations. The file access method of the mobile communication device 150_K may therefore be adjusted according to different design considerations.

In the embodiments above, the electronic message transmitted from the file providing device 110 to the mobile communication device 150_K comprises the encrypted electronic file and the challenge value but does not comprise the response value. The challenge value cannot be used to decrypt the encrypted electronic file directly. The encrypted electronic file may only be decrypted with the response value, which is generated according to the challenge value and the challenge-response generating algorithm of the target recipient. Moreover, the challenge-response generating algorithm is stored in the database 114 and the challenge-response module 170_K. Even if other persons receive the encrypted electronic file and the challenge value, the encrypted electronic file still cannot be decrypted without the challenge-response generating algorithm of the target recipient. The security of the electronic file delivery is therefore enhanced.

Moreover, the file providing device 110 may encrypt different electronic files with different response values. Therefore, even if a malicious person obtains one of the response values, only one of the electronic file may be decrypted and other electronic files still remain secure.

In the embodiments above, the challenge-response module 170_K may be realized with a thin circuit board for sticking to the SIM of the mobile communication device 150_K. Moreover, the structure of the thin circuit board may be configured so that the circuit board will be damaged and malfunction after detached from the SIM. Thus, even if unauthorized persons obtain the SIM and the attached challenge-response module 170_K, the detached challenge-response module 170_K still may not function normally by attaching it to another SIM.

Moreover, the target recipient may adopt further protection measures to the mobile communication device 150_K. For example, the challenge-response module 170_K may only be accessed by entering password (e.g., the PIN of the SIM) in advance. Even if a malicious person obtains the mobile communication device 150_K, the challenge-response module 170_K still cannot be accessed without entering the password in advance. Thus, the target recipient does not need to frequently change the passwords and worry about memorizing the new passwords. The operations are simplified and the security of the electronic file delivery is still maintained.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An electronic file delivery system, comprising:
an electronic file providing device, comprising:
a database for storing a plurality of challenge-response generating algorithms;
a processor for searching the database for a challenge-response generating algorithm of a target recipient according to an information of the target recipient, and for generating a challenge value and a corresponding response value according to the challenge-response generating algorithm of the target recipient and the challenge value;
an encryption module for encrypting an electronic file into an encrypted electronic file according to the response value; and
a communication interface for transmitting the encrypted electronic file and the challenge value to a mobile communication device; and
the mobile communication device, comprising:
a wireless communication interface for receiving the encrypted electronic file and the challenge value;
a challenge-response module, for storing the challenge-response generating algorithm of the target recipient, and for generating the response value according to the challenge value and the challenge-response generating algorithm of the target recipient; and
a decryption module, for decrypting the encrypted electronic file according to the response value.

2. A computer program product on a computer readable medium, for configuring a mobile communication device to perform a decryption key generation operation after receiving an encrypted electronic file and a challenge value, wherein the decryption key generation operation comprises:
receiving an input value from a user interface of the mobile communication device;
transmitting the input value to a challenge-response module through a communication interface of the mobile communication device; and
receiving a response value provided by the challenge-response module according the input value transmitted through the communication interface;
wherein the mobile communication device may decrypt the encrypted electronic file according to the response value when the input value matches the challenge value.

3. The computer program product of claim 2, wherein the decryption key generation operation further comprises:
comparing a password input with a predetermined value to authenticate the user of the mobile communication device.

4. The computer program product of claim 3, wherein the process of authenticating the user of the mobile communication device further comprises:
displaying a password input request message on a display interface of the mobile communication device;
receiving the password input through the user interface; and
comparing the password input with the predetermined value.

5. The computer program product of claim 4, wherein the predetermined value is a personal identification number of a subscriber identity module configured of the mobile communication device.

6. A computer program product on a computer readable medium, for configuring a mobile communication device to perform a decryption operation after receiving an encrypted electronic file and a challenge value, wherein the decryption operation comprises:
transmitting the challenge value to a challenge-response module through a communication interface of the mobile communication device;
receiving a response value generated according to the challenge value from the challenge-response module through the communication interface; and
decrypting the encrypted electronic file with a decrypting module of the mobile communication device according to the response value.

7. The computer program product of claim 6, wherein the decryption operation further comprises:
comparing a password input with a predetermined value to authenticate the user of the mobile communication device.

8. The computer program product of claim 7, wherein the process of authenticating the user of the mobile communication device further comprises:
displaying a password input request message on a display interface of the mobile communication device;
receiving the password input through the user interface; and
comparing the password input with a predetermined value.

9. The computer program product of claim 8, wherein the predetermined value is a personal identification number of a subscriber identity module configured of the mobile communication device.

10. A computer program product on a computer readable medium, for configuring an electronic file providing device to perform a file providing operation, wherein the file providing operation comprises:
generating a challenge value and a corresponding response value according to a challenge-response generating algorithm of a target recipient of an electronic file, wherein the challenge value is different from the response value;
generating an encrypted electronic file by encrypting the electronic file with the response value; and
transmitting the encrypted electronic file and the challenge value to one or more devices of the target recipient.

11. The computer program product of claim 10, wherein the file providing operation further comprises:
searching the challenge-response generating algorithm in a database according to an information of the target recipient;
wherein the database stores a plurality of challenge-response generating algorithms, each of which corresponds to one of a plurality of recipients.

12. A mobile communication device, comprising:
a wireless communication interface for receiving an encrypted electronic file and a challenge value;
a challenge-response module for providing a response value according to the challenge value and a challenge-response generating algorithm; and
a decryption module for decrypting the encrypted electronic file with the response value.

13. The mobile communication device of claim 12, wherein the challenge-response module comprises a storage device for storing the challenge-response generating algorithm and may be attached to a subscriber identity module of the mobile communication device for providing the response value according to the challenge value and the challenge-response generating algorithm.

14. The mobile communication device of claim 12, wherein the storage device comprises a circuit board.

15. A computer program product on a computer-readable medium, for configuring a mobile communication device to perform a decryption operation after receiving an encrypted electronic file and a challenge value, the decryption operation comprising:
displaying a request for entering a challenge value on a display interface of the mobile communication device after receiving a decryption key generating instruction;
receiving a first input value from a user interface of the mobile communication device;
displaying a response value on the display interface of the mobile communication device when an external storage device storing a challenge-response generating algorithm is detachably coupled with the mobile communication device;
receiving a second input value from the user interface; and
decrypting the encrypted electronic file with a decryption module of the mobile communication device when the first input value matches to the challenge value and the second input value matches the response value.
